(19) United States
(12) Patent Application Publication
(10) Pub. No.: US 2025/0283709 A1
(43) Pub. Date: Sep. 11, 2025

(54) RULER POSITIONING DEVICE AND INSTALLING AND MEASURING METHOD THEREOF

(71) Applicants: University of Science and Technology Beijing, Beijing (CN); Taiyuan Silian Heavy Industry Co., Ltd, Taiyuan (CN)

(72) Inventors: Bailin FAN, Beijing (CN); Xiaowu LI, Beijing (CN); Chen LEI, Taiyuan (CN); Chaoyang SUN, Beijing (CN); Rong WANG, Taiyuan (CN)

(21) Appl. No.: 18/954,135

(22) Filed: Nov. 20, 2024

(30) Foreign Application Priority Data
Mar. 7, 2024 (CN) 202410262123.6

(51) Int. Cl. G01B 3/04

(52) U.S. Cl. CPC G01B 3/04

(57) ABSTRACT

A ruler positioning device and an installing and measuring method thereof are provided. The device includes a reading head having a reading head body, rollers and ruler positioning frames and a spherical socket connector. A bottom of the reading head body is provided with a through groove, the rollers are arranged at a lower part of the reading head body; a front side and a back side of the reading head body are respectively provided with the ruler positioning frames; each ruler positioning frame is provided with a ruler positioning hole; a top of the reading head body is provided with a boss; the top of the boss is provided with a groove; the spherical socket connector includes a base fixed on the boss and a ball installed in the base; and the ball is provided with a long hole.

### CROSS-REFERENCE TO RELATED APPLICATIONS

This application claims priority to Chinese Patent Application No. 202410262123.6, filed on Mar. 7, 2024, the contents of which are hereby incorporated by reference.

### TECHNICAL FIELD

The disclosure relates to the technical field of positioning devices, and in particular to a ruler positioning device and an installing and measuring method thereof.

### BACKGROUND

Generally, the ruler positioning device is used to realize the long-distance coordinate positioning of walking mechanism with rails, which includes a ruler, a reading head, a mounting frame and a data acquisition box. However, in the process of equipment operation, the existing ruler positioning device has problems such as stability and accuracy, which leads to the inability to realize automatic linkage of multiple devices.

The reasons for the insufficient stability and inaccurate accuracy of the ruler positioning device are as follows: the ruler passes through the through groove below the reading head, and the width of the through groove is much larger than the thickness of the ruler, which leads to the complete separation between the ruler and the reading head, and there is great uncertainty in the relative position between the ruler and the reading head, which will lead to the phenomenon of low stability and inaccurate accuracy in positioning. The ruler is long (about 200 m) and thin (about 0.5 mm). When the working environment is an open factory building, the ruler will be affected by temperature and weather (such as windy), and the ruler will swing or shake to some extent when working, resulting in disturbance errors. The reading head is installed on a large-scale heavy-duty rail traveling mechanism (such as a rail carrier, hereinafter referred to as large-scale equipment), and the large-scale equipment will vibrate during starting, stopping and moving. And the steel frame structure of large-scale equipment will also be deformed due to the large size. The reading head is rigidly connected with the equipment, which will inevitably transfer the vibration and deformation of the equipment to the terminal installation of the reading head, causing displacement disturbance in the up-and-down height direction, left-and-right width direction and rotation disturbance deformation in any direction. In addition, the vibration shock during the starting, stopping and moving of large-scale equipment will also affect the accuracy of laser positioning measuring instruments inside the reading head. There are left and right straightness deviations and height deviations in the rail, which cause the height and spacing between the reading head and the ruler to change at any time, and the reading head in individual area is beyond the adjustment range (the reading head is ±10 mm from the center of the ruler). It is very difficult to change the working conditions (such as adjusting the rail, reducing the vibration of the vehicle, etc.), so a new structure of ruler positioning device is needed, which is not affected by the above working conditions and has high stability and accuracy.

### SUMMARY

Therefore, the present disclosure provides a ruler positioning device and an installing and measuring method to solve one or more of the above problems.

In order to achieve the above objectives, the present disclosure provides the following technical solution.

An aspect of the disclosure provides a ruler positioning device, which includes a reading head. The reading head includes a reading head body, rollers and ruler positioning frames and a spherical socket connector. A bottom of the reading head body is provided with a through groove penetrating through front and rear side surfaces of the reading head body. The rollers are arranged at a lower part of the reading head body, and the rollers are arranged at left and right sides of the through groove. A front side and a rear side of the reading head body are respectively provided with the ruler positioning frames. Each of the ruler positioning frames is provided with a ruler positioning hole. A top of the reading head body is provided with a boss, and a top of the boss is provided with a groove. The spherical socket connector includes a base and a ball, the base is fixed on the boss; the ball is installed in the base, and the ball is exposed at upper and lower sides of the base, and the ball is provided with a long hole penetrating upper and lower sides of the ball. A lower end of the long hole is in communication with the groove of the boss.

In an embodiment, a number of the rollers is four, and the rollers are respectively arranged at four corners of the lower part of the reading head body.

In an embodiment, each of the rollers includes a roller frame, a wheel body and a rotating shaft, and the roller frame is fixed on the bottom of the reading head body; the wheel body is connected with the roller frame through the rotating shaft, and an axis of the rotating shaft is arranged along a left-right direction.

In an embodiment, the ruler positioning hole is a slit groove, and a width of the slit groove is 1 to 2.5 times a thickness of a ruler.

In an embodiment, the base includes an upper base and a lower base, and the upper base is provided with a first spherical hole tapering from bottom to top and penetrating through upper and lower surfaces of the upper base; the lower base is provided with a second spherical hole tapering from top to bottom and penetrating through upper and lower surfaces of the lower base; and a diameter of a lower end of the first spherical hole and a diameter of an upper end of the second spherical hole are equal to a diameter of the ball.

In an embodiment, the upper base is detachably fixed on the lower base, and the lower base is detachably fixed on the boss.

In an embodiment, a hole wall of the long hole is coated with a wear-resistant layer, or the ball is made of wear-resistant material.

In an embodiment, a width of the long hole is greater than a width of an inserting rod, and a thickness of the long hole is adapted to a thickness of the inserting rod.

In an embodiment, the ruler positioning device further includes the ruler, and the ruler is installed on a ruler mounting frame; the ruler is vertically placed and extends in a front-rear direction, and two reading head guide rails are arranged on the ruler mounting frame; the two reading head guide rails extend in the front-rear direction and are respectively located at two sides of the ruler; the rollers, at the left and right sides of the through groove, are placed on the two reading head guide rails, and the ruler passes through the through groove and the ruler positioning hole.

Another aspect of the disclosure provides an installing and measuring method using the ruler positioning device mentioned above, the method includes following steps:
arranging the ruler mounting frame, laying the reading head guide rails on the ruler mounting frame, and installing the ruler, two reading head guide rails are laid in parallel, and the ruler is positioned between the two reading head guide rails and is higher than the reading head guide rails;
arranging the inserting rod extending downward on a vehicle body of a rail walking mechanism;
aligning the long hole of the spherical socket connector with the inserting rod, and moving the reading head upward so as to insert the inserting rod into the long hole;
aligning the rollers of the reading head with the two reading head guide rails, aligning the ruler positioning hole with the ruler, moving the reading head downward, and enabling the rollers to contact with the reading head guide rails, so as to movably install the reading head on the reading head guide rails;
when the rail walking mechanism moves, driving the reading head to move synchronously with the rail walking mechanism through the inserting rod;
with a relative movement between the reading head and the ruler, scanning grids on the ruler by a scanning element in the through groove of the reading head, and transmitting scanning information to a data processor; and
judging a walking direction of the reading head relative to the ruler by the data processor according to the transmitted scanning information, and determining an actual position of the reading head relative to the ruler in real time.

The disclosure has the following advantages.

The reading head is movably installed on the reading head guide rails through rollers, and the inserting rod of the large-scale heavy-duty rail walking mechanism are inserted into the long hole of the spherical socket connector, so that the displacement disturbance and deformation of the rail vehicle in the up-and-down height direction and the left-and-right width direction are eliminated through the up-and-down free movement and the left-and-right clearance during assembly, and only the acting force in the forward direction is transmitted to the reading head body, so that the reading head only moves in the forward direction of the guide rails. The ruler passes through a wider through groove and a narrower ruler positioning hole, and the ruler positioning hole limits the ruler in the left and right direction, so that the disturbance, deformation and movement impact of the large-scale heavy-duty rail walking mechanism on the reading head connected at the tail end position are minimized, thus achieving higher accuracy and stability.

### BRIEF DESCRIPTION OF THE DRAWINGS

In order to explain the embodiment of the present disclosure or the technical scheme in the prior art more clearly, the drawings needed in the description of the embodiment or the prior art will be briefly introduced below. Apparently, the attached drawings in the following description are only exemplary. For one of ordinary skill in the art, other implementation drawings may be obtained by extension according to the attached drawings without creative effort.

The structures, proportions, sizes, etc. shown in this specification are only used to match the contents disclosed in the specification for people familiar with this technology to understand and read, and are not used to limit the conditions for the implementation of the disclosure, so they have no technical significance. Any modification of the structure, change of the proportion relationship or adjustment of the size should still fall within the scope of the technical contents disclosed in this disclosure without affecting the benefits and objectives that may be achieved by the disclosure.

FIG. 1 is a schematic structural diagram of a ruler positioning device installed on a ruler mounting frame and reading head guide rails according to an embodiment of the present disclosure.

FIG. 2 is a schematic structural diagram of the ruler positioning device according to the embodiment of the present disclosure.

FIG. 3 is a schematic structural diagram of a reading head body and ruler positioning frames of the ruler positioning device according to the embodiment of the present disclosure.

FIG. 4 is an enlarged view of A in FIG. 3.

FIG. 5 is a schematic structural diagram of a spherical socket connector of the ruler positioning device according to the embodiment of the present disclosure.

FIG. 6 is an exploded view of the spherical socket connector of the ruler positioning device according to the embodiment of the present disclosure.

FIG. 7 is schematic structural diagram of a rail walking mechanism with an inserting rod according to an embodiment of the present disclosure.

FIG. 8 is a block diagram showing a communication relationship of grids, a scanning element and a data processor

FIG. 9 is a flowchart of an installing and measuring method for the ruler positioning device according to the embodiment of the present disclosure.

### DETAILED DESCRIPTION OF THE EMBODIMENTS

The embodiments of the present disclosure will be described below by specific examples, and those skilled in the art may easily understand other advantages and effects of the present disclosure from the contents disclosed in this description. Apparently, the described embodiments are part of the embodiments of the present disclosure, but not all of them. Based on the embodiments in the present disclosure, all other embodiments obtained by on of ordinary skill in the art without creative effort belong to the scope of protection of the present disclosure.

The terms such as “upper”, “lower”, “left”, “right” and “middle” quoted in this specification are only for the convenience of description, and are not used to limit the scope of implementation of the present disclosure. The change or adjustment of their relative relationship should also be regarded as the scope of implementation of the present disclosure without substantially changing the technical content.

This embodiment provides a ruler positioning device, which is applied to a scene where a walking mechanism with a rail performs long-distance coordinate positioning. This embodiment takes the application of the ruler positioning device in the automatic operation scene of large coke oven equipment as an example.

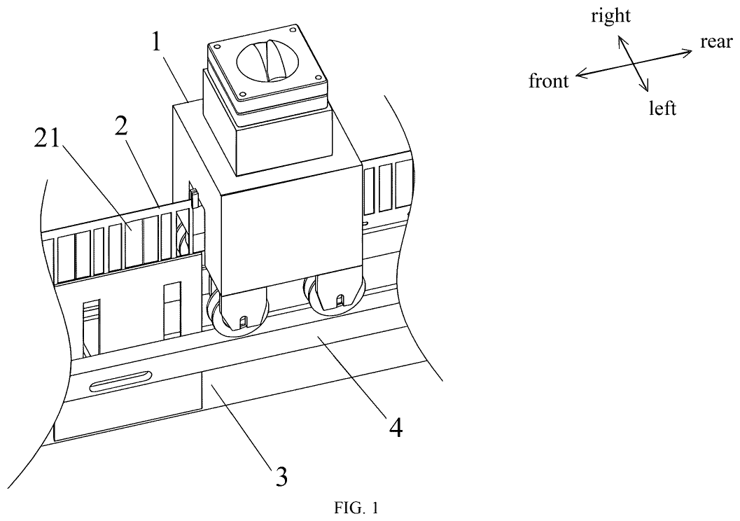

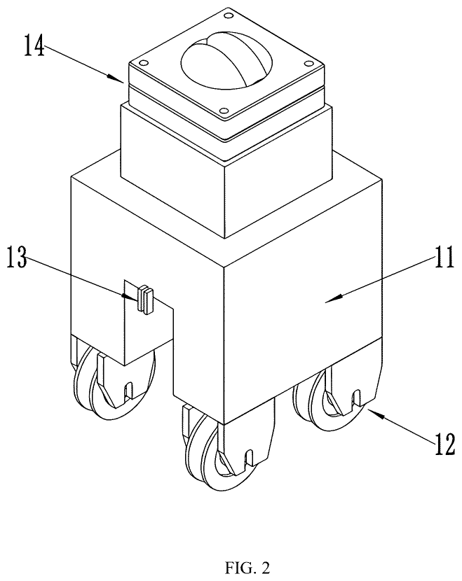

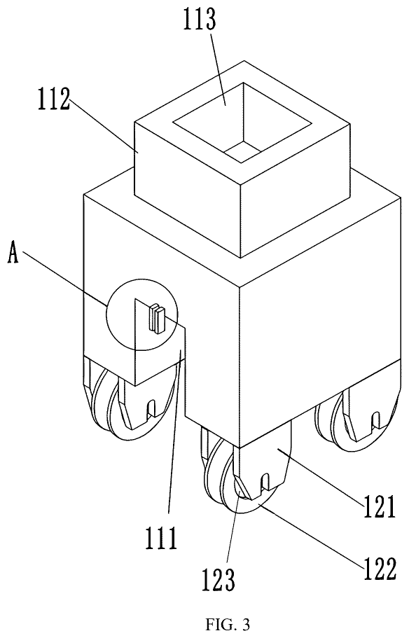

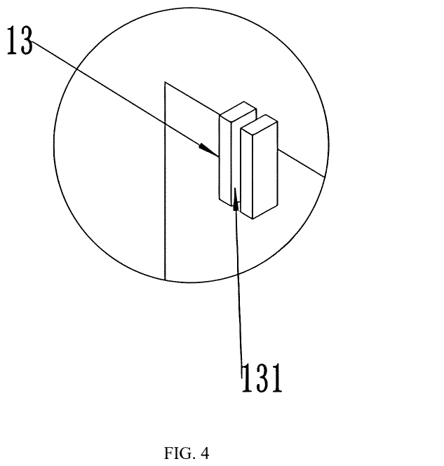

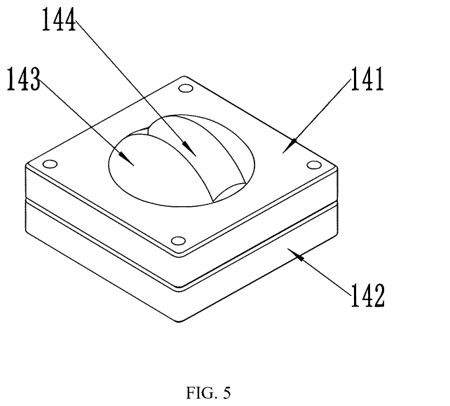

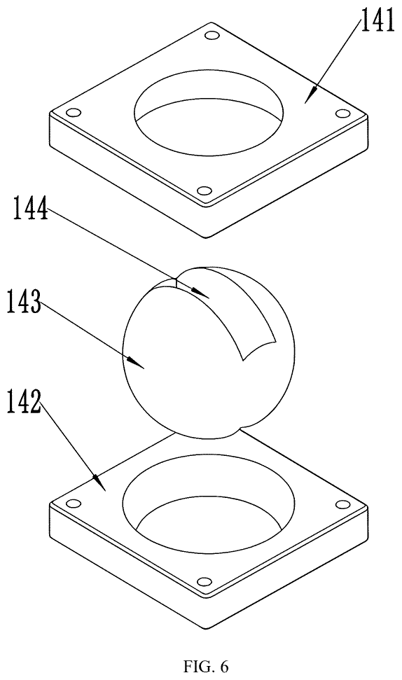

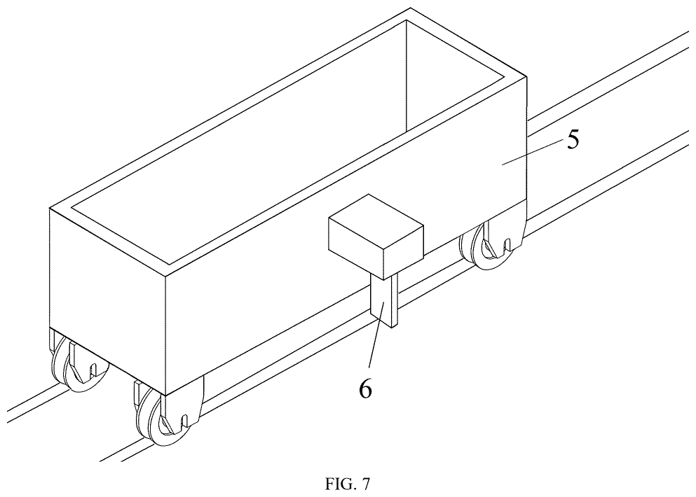

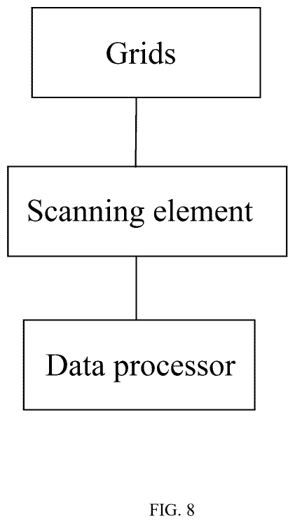

As shown in FIG. 1 to FIG. 8, the ruler positioning device provided by this embodiment includes a reading head 1 and a ruler 2. The ruler 2 is installed on a ruler mounting frame 3, the ruler 2 is vertically placed and extends in the front-rear direction. Two reading head guide rails 4 are arranged on the ruler mounting frame 3, the two reading head guide rails 4 extend in the front-rear direction and are located on both sides of the ruler 2 respectively. The reading head 1 is movably installed on the reading head guide rails 4 through rollers 12 arranged on the bottom of the reading head. After the structure of the ruler positioning device is improved, it is not fixedly connected with a rail walking mechanism 5 (large-scale heavy-duty equipment such as coal loading vehicle and coke pusher vehicle, and other rail vehicles), and the rail vehicle using the ruler positioning device of this embodiment is provided with a downward extending inserting rod 6 on the vehicle body.

The reading head 1 includes a reading head body 11, rollers 12, ruler positioning frames 13 and a spherical socket connector 14.

The bottom of the reading head body 11 is provided with a through groove 111 penetrating the front and rear side surfaces, and the through groove 111 is in communication with the bottom surface of the reading head body 11. The through groove 111 is generally located in the center of the reading head body 11 in the width direction, and the width of the through groove 111 (referring to the dimension in the left and right direction) is much larger than the thickness of the ruler 2. The top of the reading head body is provided with a boss 112 for installing the spherical socket connector 14. The top of the boss 112 is provided with a groove 113, which is used to accommodate the lower half of the ball 143 of the spherical socket connector 14, and the inserting rod 6 that protrudes downward from the long hole 144 of the ball 143 (normally, the inserting rod will not protrude from the lower end of the long hole 144, and the upward movement of the reading head may cause the inserting rod to protrude downward during installation).

The roller 12 is arranged at the lower part of the reading head body 11, and two rollers 12 are arranged on the left and right sides of the through groove 111, and the two rollers 12 on the same side are arranged in tandem at intervals. Generally, the bottom of the reading head body 11 is rectangular, and the four rollers 12 are located at the corners of the rectangle respectively. In this way, the evenly distributed rollers 12 may enable the reading head 1 to move on the reading head guide rails 4 stably. The roller 12 includes a roller frame 121, a wheel body 122 and a rotating shaft 123, the roller frame 121 is fixed on the bottom of the reading head body 11, and the wheel body 122 is connected with the roller frame 121 through the rotating shaft, and the axis of the rotating shaft is arranged along the left-right direction.

The front and back sides of the reading head body 11 are each provided with the ruler positioning frame 13, and the ruler positioning frame 13 is provided with a ruler positioning hole 131. The ruler positioning hole 131 is a slit groove, and the width of the slit groove (referring to the dimension in the left-right direction) is 1 to 2.5 times the thickness of the ruler 2. With the installed ruler positioning device, the ruler 2 not only passes through the through groove 111, but also passes through the ruler positioning hole 131. The arrangement of the ruler positioning frame 13 and the setting of the width of the ruler positioning hole 131 may effectively limit the displacement of the ruler 2 in the left-right direction and avoid the excessive amplitude of the ruler 2 shaking from left to right.

The spherical socket connector 14 includes a base and a ball 143 The base is fixed on the boss 112, the ball 143 is installed in the base, and the ball 143 is exposed at the upper and lower sides of the base, and the ball 143 is provided with a long hole 144 penetrating the upper and lower sides of the ball, and the lower end of the long hole 144 is in communication with the groove 113 of the boss. The base includes an upper base 141 and a lower base 142, the upper base 141 is provided with a spherical hole tapering from bottom to top and penetrating through upper and lower surfaces of the upper base. The lower base 142 is provided with a spherical hole tapering from top to bottom and penetrating through the upper and lower surfaces of the lower base. The lower end diameter of the spherical hole of the upper base 141 and the upper end diameter of the spherical hole of the lower base 142 are equal to the ball diameter of the ball 143. The upper base 141 is detachably fixed on the lower base 142, the lower base 142 is detachably fixed on the boss 112. Due to the long-term friction and stress on the contact surface between the long hole 144 and the inserting rod, considering the wear and service life, the hole wall of the long hole 144 is coated with a wear-resistant layer, or the ball 143 is made of wear-resistant materials, such as copper plating or brass and bronze. The width of the long hole 144 (referring to the dimension in the left-right direction) is larger than the width of the inserting rod (referring to the dimension in the left-right direction), so as to reduce the left-right shaking of the inserting rod (brought by the rail vehicle). The thickness of the long hole 144 (referring to the dimension in the front-rear direction) is adapted to the thickness of the inserting rod (referring to the dimension in the front-rear direction), and generally tolerance fit is adopted.

The reading head 1 is movably installed on the reading head guide rails 4 through the rollers 12, and the inserting rod of large-scale heavy-duty rail vehicles such as coal charging trucks and coke pusher trucks are inserted into the long hole 144 of the spherical socket connector 14, so that the displacement disturbance and deformation of the rail vehicle in the up-and-down height direction and the left-and-right width direction are eliminated through the up-and-down free movement and the left-and-right clearance during assembly, and only the force in the forward direction is transmitted to the reading head body 11, so that the reading head 1 only moves in the forward direction of the guide rails. The ruler 2 passes through the wide through groove 111 and the narrow ruler positioning hole 131, and the ruler 2 is limited in the left and right direction by the ruler positioning hole 131, so that the disturbance, deformation and movement impact of large-scale heavy-duty rail vehicle equipment such as coal charging trucks and coke pusher on the terminal-connected reading head 1 are minimized.

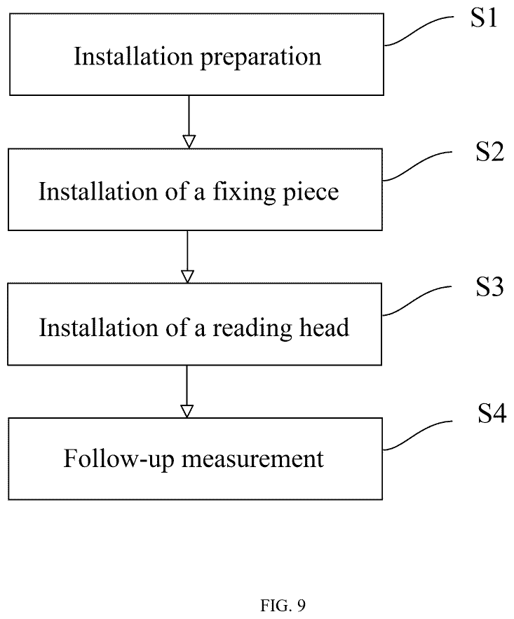

As shown in FIG. 9, this embodiment also provides an installing and measuring method using the ruler positioning device as described above, the method includes the following steps.

S1: installation preparation, specifically includes: S11: the flexibility of the ball of the spherical socket connector and the flexibility of the rollers under the reading head body are checked; and S12: check whether the ruler is damaged. S11 and S12 may be performed simultaneously, or in sequence or in reverse order.

S2: installation of a fixing piece. The fixing piece includes the ruler, the ruler mounting frame, the reading head guide rails and the like. S2 includes: S21: the ruler mounting frame is set, reading head guide rails are laid on the ruler mounting frame, and the ruler is installed; two reading head guide rails are laid in parallel, and the ruler is positioned between the two reading head guide rails and higher than the reading head guide rails; and S22: the downward extending inserting rod is arranged on the vehicle body of the rail walking mechanism. S21 and S22 may be performed simultaneously, or in the sequential or reverse order.

S3: installation of the reading head, specifically includes: S31: the long hole of the spherical socket connector is aligned with the inserting rod, and the reading head moves upward so as to insert the inserting rod into the long hole; and S32: the rollers of the reading head are aligned with the two reading head guide rails, and the ruler positioning holes are aligned with the ruler at the same time, and the reading head moves downward to enable the rollers to contact with the reading head guide rails, so that the reading head may be movably installed on the reading head guide rails. The sequence of S31 and S32 is irreversible. It should be pointed out that the reading head may also be installed in other ways.

S4: follow-up measurement, specifically includes: S41: when the rail walking mechanism moves, the reading head is driven to move synchronously with the rail walking mechanism through the inserting rod; S42: with the relative movement between the reading head and the ruler, grids 21 on the ruler are scanned by a scanning element in the through groove of the reading head, and the scanning information is transmitted to a data processor; and S43: the walking direction of the reading head relative to the ruler is judged by the data processor according to the transmitted scanning information, and the actual position of the reading head relative to the ruler is determined in real time. The sequence from S41 to S43 is irreversible. It should be pointed out that the follow-up measurement step may adopt the data processing method in the prior art.

Although the present disclosure has been described in detail with general descriptions and specific examples, it is obvious to those skilled in the art that some modifications or improvements may be made on the basis of the present disclosure. Therefore, these modifications or improvements made without departing from the spirit of the disclosure belong to the scope of the disclosure.

What is claimed is:

1. A ruler positioning device, comprising:
a reading head comprising a reading head body, rollers and ruler positioning frames and a spherical socket connector;
wherein a bottom of the reading head body is provided with a through groove penetrating through front and rear side surfaces of the reading head body; the rollers are arranged at a lower part of the reading head body, and the rollers are arranged at left and right sides of the through groove; a front side and a rear side of the reading head body are respectively provided with the ruler positioning frames; each of the ruler positioning frames is provided with a ruler positioning hole; a top of the reading head body is provided with a boss, and a top of the boss is provided with a groove; the spherical socket connector comprises a base and a ball, the base is fixed on the boss; the ball is installed in the base, and the ball is exposed at upper and lower sides of the base; and the ball is provided with a long hole penetrating upper and lower sides of the ball, and a lower end of the long hole is in communication with the groove of the boss.

2. The ruler positioning device according to claim 1, wherein a number of the rollers is four, and the rollers are respectively arranged at four corners of the lower part of the reading head body.

3. The ruler positioning device according to claim 1, wherein each of the rollers comprises a roller frame, a wheel body and a rotating shaft, and the roller frame is fixed on the bottom of the reading head body; and the wheel body is connected with the roller frame through the rotating shaft, and an axis of the rotating shaft is arranged along a left-right direction.

4. The ruler positioning device according to claim 1, wherein the ruler positioning hole is a slit groove, and a width of the slit groove is 1 to 2.5 times a thickness of a ruler.

5. The ruler positioning device according to claim 1, wherein the base comprises an upper base and a lower base, and the upper base is provided with a first spherical hole tapering from bottom to top and penetrating through upper and lower surfaces of the upper base; the lower base is provided with a second spherical hole tapering from top to bottom and penetrating through upper and lower surfaces of the lower base; and a diameter of a lower end of the first spherical hole and a diameter of an upper end of the second spherical hole are equal to a diameter of the ball.

6. The ruler positioning device according to claim 5, wherein the upper base is detachably fixed on the lower base, and the lower base is detachably fixed on the boss.

7. The ruler positioning device according to claim 1, wherein a hole wall of the long hole is coated with a wear-resistant layer, or the ball is made of wear-resistant material.

8. The ruler positioning device according to claim 1, wherein a width of the long hole is greater than a width of an inserting rod in a left-right direction, and a thickness of the long hole is adapted to a thickness of the inserting rod in a front-rear direction.

9. The ruler positioning device according to claim 1, further comprising a ruler, wherein the ruler is installed on a ruler mounting frame, and the ruler is vertically placed and extends in a front-rear direction; two reading head guide rails are arranged on the ruler mounting frame, and the two reading head guide rails extend in the front-rear direction and are respectively located at two sides of the ruler; and the rollers arranged at the left and right sides of the through groove are placed on the two reading head guide rails, and the ruler passes through the through groove and the ruler positioning hole.

10. An installing and measuring method using the ruler positioning device according to claim 9, comprising following steps:
arranging the ruler mounting frame, laying the reading head guide rails on the ruler mounting frame, and installing the ruler, wherein the two reading head guide rails are laid in parallel, and the ruler is positioned between the two reading head guide rails and is higher than the reading head guide rails;
arranging an inserting rod extending downward on a vehicle body of a rail walking mechanism;
aligning the long hole of the spherical socket connector with the inserting rod, and moving the reading head upward so as to insert the inserting rod into the long hole;
aligning the rollers of the reading head with the two reading head guide rails, aligning the ruler positioning hole with the ruler, moving the reading head downward, and enabling the rollers to contact with the reading head guide rails, so as to movably install the reading head on the reading head guide rails;
when the rail walking mechanism moves, driving the reading head to move synchronously with the rail walking mechanism through the inserting rod;
with a relative movement between the reading head and the ruler, scanning grids on the ruler by a scanning element in the through groove of the reading head, and transmitting scanning information to a data processor, and
judging a walking direction of the reading head relative to the ruler by the data processor according to the transmitted scanning information, and determining an actual position of the reading head relative to the ruler in real time.
